(19) United States
(12) Patent Application Publication
(10) Pub. No.: US 2013/0252049 A1
(43) Pub. Date: Sep. 26, 2013

(54) Apparatus for Detecting the Temperature of an Energy Storage System

(71) Applicant: Bayerische Motoren Werke Aktiengesellschaft, Muenchen (DE)

(72) Inventors: Matthias FLECKENSTEIN, Muenchen (DE); Thomas HOEFLER, Groebenzell (DE); Axelle HAUCK, Neubiberg (DE); Tuncay IDIKURT, Muenchen (DE)

(73) Assignee: Bayerische Motoren Werke Aktiengesellschaft, Muenchen (DE)

(21) Appl. No.: 13/898,837

(22) Filed: May 21, 2013

Related U.S. Application Data
(63) Continuation of application No. PCT/EP2011/005214, filed on Oct. 18, 2011.

(30) Foreign Application Priority Data
Nov. 30, 2010 (DE) 10 2010 062 207.9

(51) Int. Cl. H01M 6/42; H01M 10/48

(52) U.S. Cl. CPC H01M 6/42; H01M 10/482
USPC 429/90

(57) ABSTRACT

An apparatus for detecting the temperature of an electrochemical energy storage system, in particular for use in a motor vehicle, includes a temperature sensor unit. The energy storage system has one or more storage cells with, in each case, two connection terminals for making electric contact therewith. The connection terminals are in electric contact via connection elements. In order to detect a temperature corresponding to an internal temperature of the storage cells, a respective temperature sensor of the temperature sensor unit is arranged on a connection terminal of at least one of the storage cells of the energy storage system.

### CROSS REFERENCE TO RELATED APPLICATIONS

This application is a continuation of PCT International Application No. PCT/EP2011/005214, filed Oct. 18, 2011, which claims priority under 35 U.S.C. §119 from German Patent Application No. DE 10 2010 062 207.9, filed Nov. 30, 2010, the entire disclosures of which are herein expressly incorporated by reference.

### BACKGROUND AND SUMMARY OF THE INVENTION

The invention relates to an apparatus for detecting the temperature of an electrochemical energy storage system having a temperature sensor unit.

The efficiency of an electrochemical energy storage system depends on its operating temperature. This particularly but not exclusively applies to those energy storages devices which use lithium ion storage cells. An energy storage system used in the environment of motor vehicles typically comprises a plurality of storage cells which are mutually electrically connected in a serial and/or parallel manner in order to be able to provide a predefined output voltage and a predefined output current. In the storage modules currently being developed, the storage cells are based on the initially mentioned lithium ion technology. These storage cells are ideally operated in a temperature range of between +5° C. and +40° C. When the operating temperature of the storage cells exceeds the upper temperature limit, accelerated aging takes place, so that the demanded service life frequently cannot be met. In contrast, when the storage cells are operated below the lower temperature limit, the efficiency of the cell is considerably reduced. In addition, the storage cells can be operated only inefficiently in this temperature range. When energy storage systems are used in the field of motor vehicles, these energy storage systems are therefore tempered.

In order to be able to carry out the tempering of the storage cells as precisely and efficiently as possible, a detection of the current temperature of the storage cells is required that is as accurate as possible. Based on the detected current temperature of the storage cells, the automatic temperature control takes place for cooling or heating the storage cells. The automatic control takes place by way of a two-position control device. During the cooling of the storage cells, a cooling device is switched on by the two-position control device when a defined upper limit value of the measured temperature is exceeded and is switched off again when there is a falling below a lower limit value. During the heating, a heating device is switched on when there is a falling below a further defined lower limit value and is switched off when this limit value is exceeded.

The more precisely the measured current temperatures of the storage cells correspond to the actual temperatures of the storage cells in their interiors, the more precisely the limit values of the automatic control can be defined. As a result, the control can also take place in an optimized manner. In contrast, the greater the deviation between the actual current temperature of the storage cells in their interiors and the measured current temperature, the longer the idle times that have to be taken into account for the automatic control. This leads to a lowering of the control precision, and, in addition, may result in a frequent switching-on and switching-off of the cooling or heating device. This results in strong temperature fluctuations in the interior of the storage cells, which may have a limiting effect on their service life. On the other hand, additional energy has to be generated for the cooling and heating, which is the higher, the less precisely the control takes place.

From U.S. Pat. No. 4,572,878, it is known to arrange a temperature sensor on the underside of a connection element of a cable for contacting the energy storage system. If the cable is electrically and mechanically fastened to an assigned connection terminal of the energy storage system, the temperature sensor will detect the temperature on the exterior side of a case of the energy storage system. One disadvantage of this approach consists of the fact that it does not precisely detect the temperature in the interior of the energy storage system.

From US 2010/0073005 A1, it is further known to arrange a temperature sensor on a printed circuit board. In this case, the printed circuit board is arranged adjacent to the connection terminal of the storage cells of the energy storage system. In addition to the temperature sensor, the printed circuit board comprises additional electronic components for monitoring and regulating the energy storage system. Although the temperature sensor by way of a thermally conductive material is thermally coupled with the case of one of the storage cells, no realistic detection of the internal temperature of the storage cells takes place because of the thermal resistances as a result of small cross-sectional surfaces of the connection.

It is therefore an object of the present invention to provide an apparatus by which the detection of the temperature of an electrochemical energy storage system, particularly for use in a motor vehicle, can take place in a more precise manner.

This and other objects are achieved by an apparatus for detecting the temperature of an electrochemical energy storage system, particularly for use in a motor vehicle, having a temperature sensor unit. The energy storage system has one or more storage cells with two connection terminals respectively for their electric contacting, which connection terminals are electrically contacted by way of connection elements. For detecting a temperature corresponding to the internal temperature of the storage cells, the temperature sensor unit is arranged on a connection terminal of at least one of the storage cells of the energy storage system.

The invention is based on the recognition that the connection terminals represent those areas of a storage cell which, as a result of their electrical connection with the electrodes and electrolytes arranged in the interior of the storage cell, are also thermally best connected with these temperature-sensitive components. It can thereby be ensured that, by use of the temperature sensor unit, a temperature can be detected that corresponds to the internal temperature of the storage cells. An automatic control evaluating the temperature signal of the temperature sensor unit can then operate with a precision that is greater compared to the state of the art. This is a result of the fact that the temperature signal detected by the temperature sensor unit better reflects the dynamics of the temperature course in the interior of the storage cells.

The temperature sensor of the temperature sensor unit is preferably arranged on that connection terminal of a storage cell which has an electrical connection with a case of the concerned storage cell. The electrical and therefore thermal linking of the connection terminal to the case of the corresponding storage cell leads to a moderation of the connection temperature which, without the linkage to the case (opposite connection), as a result of high current pulses, exhibits increased temperature jumps in comparison to the internal cell temperature. According to results of tests that were carried out, precisely these moderating characteristics provide a temperature value for an automatic control, which temperature value has the dynamics of the temperature course analogous to the cell interior.

It is noted that a temperature representative of the cell interior can also be measured at a connection terminal not electrically connected with the case. Although thereby the dynamics of the system are not detected as well, this can easily be factored in by use of corresponding evaluation software.

In a first variant, the temperature sensor of the temperature sensor unit is arranged directly on one of the connection terminals of the at least one storage cell. The temperature prevailing in the interior of the storage cell can thereby be detected by the temperature sensor with the least-possible error. In a further development of this variant, the temperature sensor is arranged in a blind hole of the connection element directly on the connection terminal.

In a second variant, the temperature sensor of the temperature sensor unit is arranged on a connection element electrically and thermally conductingly connected with one of the connection terminals. This variant permits a facilitated manufacturing of the energy storage system because a large-surface electrical connection can be established between the connection terminal and the connection element.

In the case of this variant, it is particularly advantageous for the temperature sensor to be arranged outside a connection area of the connection terminal and the connection element on the connection element. This arrangement in the so-called “shadow of the current” ensures that the simulation of the temperature prevailing in the interior of the storage cells is improved. In particular, the temperature signal is not influenced by briefly flowing high currents, which would lead to an unsteady control behavior.

For this purpose, the connection element advantageously has a tab or “flag” which is formed outside the connection area of the connection terminal and connection element, on which the temperature sensor is arranged. The providing of the temperature sensor on the tab of the connection element further permits the mounting of the temperature sensor in an optimized manner with respect to space. It is particularly not required that the tab and the connection element are situated in a common plane of the connection element. On the contrary, the tab may be aligned at an angle relative to the plane of the connection element, whereby less space is needed laterally of the electric contacting of the connection terminal and the connection element.

In a further advantageous development, the connection element is either a cell connector, which electrically mutually connects the connection terminals of two storage cells, or a module connector, by way of which the energy storage system can be electrically contacted, particularly by way of a plug-in connection. By use of a cell connector, storage cells are thereby electrically or parallel connected with one another within the energy storage system. The module connectors are used for contacting the energy storage system from the outside.

Furthermore, it is expedient for the temperature sensor unit to comprise at least two temperature sensors, which detect the temperatures at different storage cells, in which case the temperature signals of the at least two temperature sensors can be fed to a logic unit for evaluation. The providing of several temperature sensors in the temperature sensor unit makes it possible to, for example, find possible faults in the electric circuitry of the energy storage system. In particular, it becomes possible to find faults by a comparison of respective temperature signals. The detection of several temperature signals at several locations within the energy storage system further permits a more precise automatic control of the heating or cooling system.

In a further advantageous development, a first temperature sensor is thermally coupled with a connection terminal of a storage cell, which connection terminal is electrically connected with a connection element constructed as the module connector, and a second temperature sensor is thermally coupled with a connection terminal of a storage cell, whose two connection terminals are each electrically connected with a connection element constructed as a cell connector. As a result it becomes possible to detect faults in the electric circuitry during the electric contacting of the energy storage system. This is significant particularly because the module connectors of the energy storage system are frequently connected with detachable or plug-in connections. A poor electric connection leads to an increased contact resistance, which becomes noticeable by a higher temperature. This increased temperature is detected by the second temperature sensor. Even the presence of a deviation of the temperature signals from the first and second sensor can be evaluated by a logic as an indication that a fault is present.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 is a schematic lateral view of an energy storage system;

FIG. 2 is a schematic and perspective sectional view of a part of a storage cell of the energy storage system of FIG. 1;

FIG. 3 is a sectional lateral view of a storage cell of FIG. 2 equipped according to an embodiment of the invention with a temperature sensor;

FIG. 4 is a partial top view of an apparatus of the invention according to a first embodiment;

FIGS. 5a, 5b are a partial top view and a lateral view, respectively, of an apparatus of the invention according to a second embodiment;

FIGS. 6a, 6b are a partial top view and a lateral view, respectively, of an apparatus of the invention according to a third embodiment;

FIGS. 7a, 7b are a partial top view and a lateral view, respectively, of an apparatus of the invention according to a fourth embodiment; and

FIG. 8 is a top view of an apparatus of the invention according to a fifth embodiment.

### DETAILED DESCRIPTION OF THE DRAWINGS

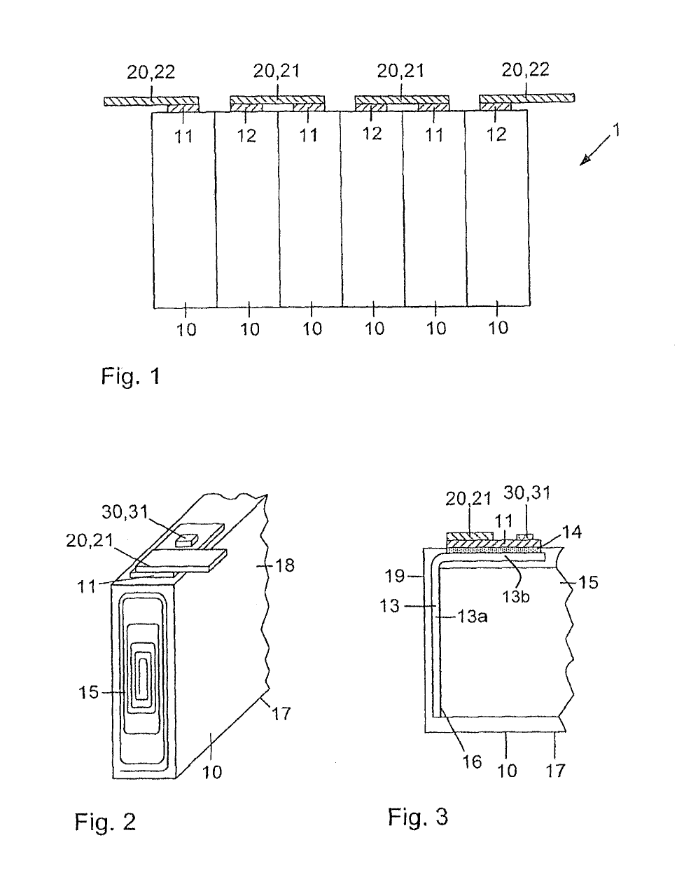

FIG. 1 is a lateral schematic view of an electrochemical energy storage system 1, as used, for example, in battery-operated motor vehicles. In the embodiment, the energy storage system 1 comprises six successively arranged prismatic storage cells 10. In principle, the electrochemical energy storage system could also be formed of a plurality of cylindrical storage cells.

Each of the storage cells 10 has two connection terminals 11 and 12. The first connection terminal 11, for example, represents the positive pole; the second connection terminal 12 represents the negative pole of the storage cell 10. The positive pole is usually electrically connected with the case of the storage cell. In the lateral view of FIG. 1, only one of the two connection terminals 11, 12 is visible in each case. In the embodiment illustrated in FIG. 1, the storage cells 10 are successively arranged such that the second connection terminal 12 of the adjacent storage cell 10 will be situated adjacent to a first connection terminal 11 of the storage cell 10. As a result of the fact that, in each case, two mutually adjacently arranged connection terminals 11, 12 are arranged side-by-side, a serial wiring of the storage cells can take place by using connection elements 20. It is also contemplated that two mutually adjacently arranged identical connection terminals 11, 11 and 12, 12 respectively are arranged side-by-side, in order to wire the adjacent cells in a parallel manner. Higher currents can thereby be provided by the electric energy storage system.

The connection elements 20 marked by reference number 21 represent cell connectors and connect two side-by-side connection terminals 11, 12 of adjacent storage cells respectively. The connection elements marked by reference number 22 represent module connectors, by way of which the complete circuit of storage cells 10 can be contacted from the outside. The external contacting frequently takes place by way of a plug-in connection or another detachable connection.

The entirety of storage cells 10 is usually arranged in a case which, for reasons of simplicity, is not shown in FIG. 1. A cooling and heating system, which is integrated in the case in order to keep the storage cells in a prescribed temperature range during the operation of the energy storage system 1, is also not shown.

Storage cells 10 of an energy storage system 1 for use in a motor vehicle are currently usually based on lithium ion technology. Such storage cells are to be operated in a temperature range of from +5° C. to +40° C. Temperatures above +40° C. may lead to a reduced service life of the cells. An operation at temperatures of below +5° C. results in a reduced capacity and a lower efficiency of the respective storage cell during the operation. These problems also apply to other types of storage cells—with possibly different temperature limits.

When a prescribed temperature range of the storage cells 10 is mentioned in the present description, this applies to the temperature in the interior, i.e. where the electrochemical processes take place in the interior of the storage cell. The more precisely the measuring of the actual temperature is carried out in the interior of a respective storage cell 10, the more precisely the cooling or heating of the storage cells 10 of the energy storage system 1 can take place.

The arrangement provided according to the invention of at least one temperature sensor 31, 32 of a temperature sensor unit 30 and the resulting advantages can best be understood if the construction of typical storage cells is known. In the following, reference will be made in this regard particularly to lithium ion storage cells with a prismatic case, the described principle also being applicable to other types of storage cells.

FIG. 2 is a perspective schematic view of an individual storage cell 10. FIG. 3 is a lateral schematic sectional view of the storage cell of FIG. 2. A so-called cell winding 15 is arranged in the interior of a case 17 of the storage cell 10. The cell winding 15 consists of a stack of the cathode and anode layers, each separated from one another by a separator layer. The cell winding 15 is produced by winding the electrode stack and by a subsequent deformation (exercising pressure onto two opposite sides), so that the cell winding assumes approximately the shape of the case 17 of the storage cell 10. After the insertion of the cell winding 17 into the case 17, electrolyte is filled into the case 17. In order to prevent a short circuit from occurring between the individual winding layers, these are mutually electrically insulated by a respective insulation layer (the so-called separator). The electric insulation also always results in low thermal conductivity perpendicular through the layers of the electrode stack. This leads to high thermal resistances and therefore temperature differences between the interior of the cell winding 15 and the side wall 18 of the case, so that no realistic temperature of the interior of the storage cell 10 can be measured at the side wall 18. In comparison, such a thermal insulation does not exist on the front side 19 of the storage cell 10 because of the absence of an insulation layer.

A so-called power collector 13 is welded to the front side of the cell winding 15. The power collector 13 has an L-shaped design. With its vertical leg 13a, this power collector is electrically connected with the electrode laminate of the cell winding 15 by way of a welding/soldering. The horizontally extending leg 13b of the power collector is electrically connected with the connection terminal situated above it by way of a welded and/or riveted connection. In the embodiment, the first connection terminal 11 is electrically connected with the cell winding 15 via the connection 14 and power collector 13. The connection element 20 is electrically conductingly (for example, by welding or soldering) mounted on the side of the first connection terminal 11 facing away from the storage cell 10. Here, the connection element 20 is a cell connector 21, which establishes an electrical connection to a second connection terminal 12 of an adjacent storage cell 10 not shown in FIGS. 2 and 3. Furthermore, in a manner according to the invention, a temperature sensor 31 of the temperature sensor unit 30 is mounted directly on the first connection terminal 11.

As a result of the fact that the first connection terminal 11 is thermally linked directly to the cell winding 15 by way of the connection 14 and the power collector 13, the temperature sensor 31 supplies a temperature signal corresponding to the internal temperature of the storage cells. Here, the internal temperature of the storage cells is that temperature which occurs in the locations of the electrochemical processes of the storage cell 10.

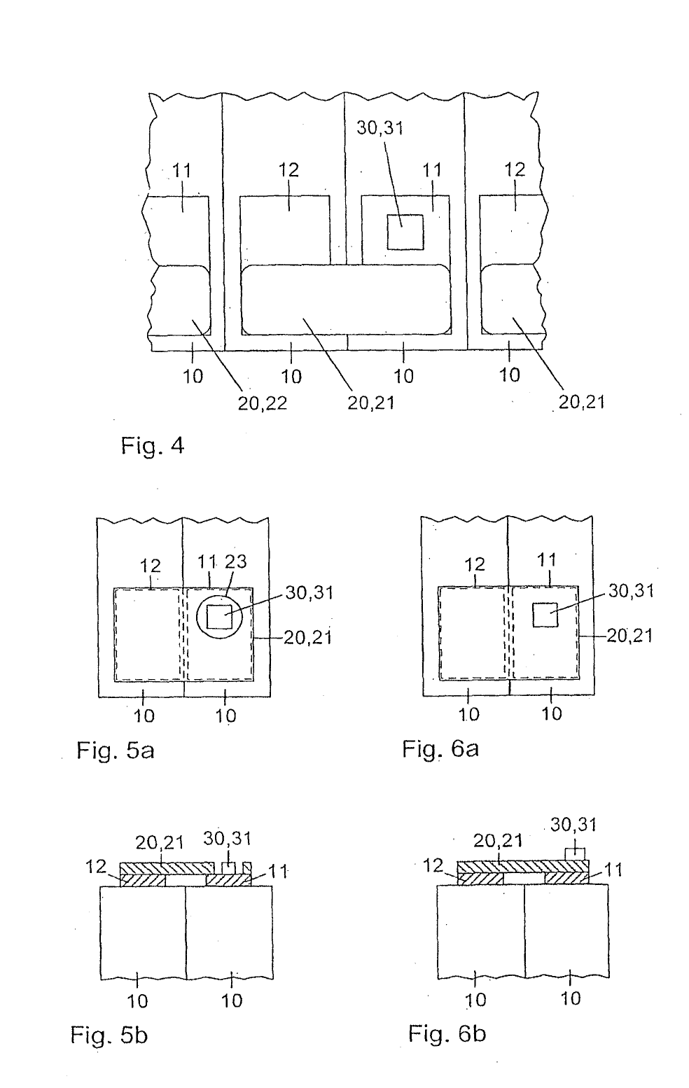

FIGS. 4 to 7 show various embodiments as to the locations where the temperature sensor 31 of the temperature sensor unit 30 can be arranged on a connection terminal 11, 12 of a storage cell 10 of the energy storage system 1.

In the embodiments according to FIGS. 4 and 5a, 5b, the temperature sensor 31 of the temperature sensor unit is arranged directly on a first connection terminal 11 of a storage cell 10 of the energy storage system 1. In the first embodiment according to FIG. 4, the cell connector 21 is constructed such that it contacts the connection terminals 11, 12 not over the full surface but, as an example, only over half the surface. The temperature sensor 31 of the temperature sensor unit 30 is arranged in the remaining half of the first connection terminal 11.

In contrast, in the second embodiment according to FIGS. 5a, 5b, the temperature sensor 31 is arranged in a blind hole 23 of the cell connector 21, the cell connector 21 being in each case connected over its full surface with the connection terminals 11, 12. The cross-sectional view of FIG. 5b illustrates how the temperature sensor 31 is arranged in the interior of the blind hole 23 on the connection terminal 11. By the arrangement in the interior of the blind hole 23, the temperature sensor 31 is protected from mechanical damage.

The advantage of these embodiments of the direct mounting of the temperature sensor on a connection terminal of a storage cell consists of the fact that the heat conduction path from the interior of the corresponding storage cell 10 to the temperature sensor 31 on the connection element 11 has to overcome the lowest thermal resistance. As a result, a temperature value can thereby be detected which best corresponds to the internal temperature of the storage cell.

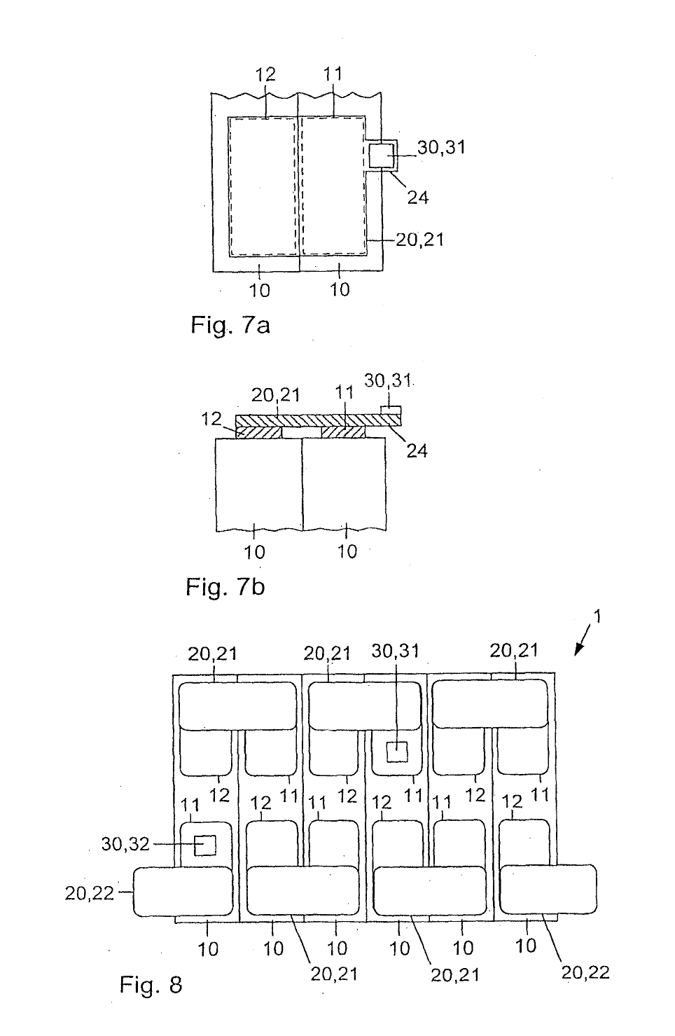

An alternative arrangement of the temperature sensor 31 is illustrated in the embodiments according to FIGS. 6 and 7. In each case, the temperature sensor 31 is arranged on the cell terminal 21, which is electrically and thermally conductingly connected with the connection terminals 11, 12 of two adjacent storage cells 10.

In the third embodiment according to FIGS. 6a and 6b, the temperature sensor 31 is arranged on the cell connector 21 directly above the connection terminal 11. In contrast, in the fourth embodiment, which is shown in FIGS. 7a and 7b, the temperature sensor 31 is arranged on a flag or tab 24 of the cell connector 21 in such a manner that the temperature sensor 31 comes to be situated outside the connection surface between the cell connector 21 and the first connection terminal 11. As illustrated in the lateral view of FIG. 7b, the tab 24 and the cell connector 21 are situated in a common plane. Should it be useful for reasons of space, the tab 24 could be arranged at an angle with respect to the cell connector 21 and could, for example, extend upward with respect to the top side of the storage cells 10. The arrangement illustrated in FIGS. 6 and 7 has the advantage that the cell connector 21 and the connection terminals 11, 12 are mutually connected in a full-surface manner, so that, in comparison to the first variant according to FIGS. 4 and 5, a lower current density will occur in the area of the connection. As a result of the fact that the temperature sensor 31 is arranged on the tab 24 of the cell connector 21, the latter is situated in the so-called “shadow of the current”, so that the temperature value detected by the temperature sensor 31 is not influenced, or is influenced only slightly, by the current flowing via the cell connector 21 and the resulting ohmic power loss.

In the embodiments illustrated in FIGS. 4 to 7, the temperature sensor 31 is shown while it is interacting with a cell connector 21. In principle, the temperature sensor 31 could also—either directly or indirectly by way of a connection element 20—be arranged on that connection terminal which is electrically connected with a module connector 22.

FIG. 8 is a top view of another embodiment of the apparatus according to the invention. Here, the, for example, six successively arranged storage cells 10 of FIG. 1 are illustrated in a top view. The storage cells 10 are serially wired to one another in a known manner by way of their respective connection elements 11, 12 by use of cell connectors 21 and module connectors 22. In this embodiment, the temperature unit 30 comprises two temperature sensors 31, 32. The temperature sensor 31 is arranged on that connection terminal 11 which is electrically coupled with a cell connector 21. In contrast, the temperature sensor 32 is connected with the connection terminal 11 of a storage cell 10 which is electrically connected with a module connector 22 for the external contacting of the energy storage system 1. By way of the temperature sensor 32, a temperature is detected which is a function not only of the internal temperature of the corresponding storage cell but also of the temperature of the plug-in connection. In the event of a faulty plug-in connection of the module connector 22, the temperature sensor 32 therefore detects a raised temperature compared to the temperature sensor 31 which detects only the internal temperature of the corresponding storage cell 10.

When further temperature signals of the temperature sensors 31, 32 are fed to a logic unit for further evaluation, the latter can, in the event of mutually considerably deviating temperatures, conclude that there is a fault in the contacting of the energy storage system by way of the module connector 11. If, in contrast, the electrical connection to the module connector 22 is free of faults, the temperature sensors 31, 32 should furnish approximately identical temperature signals.

The logic unit, to which the temperature signal or signals of the temperature sensors 31, 32 is/are fed, may be arranged, for example, on a printed circuit board, which is arranged above or laterally of the storage cells 10 of the energy storage system 1.

In a further embodiment, which is not shown, a further improved precision during the monitoring and automatic control of the storage cells of the energy storage system could be achieved in that not only individual or some of the storage cells 10 are equipped with a temperature sensor, but a temperature sensor is arranged in the above-described manner on all of the storage cells 10.

In principle, it is also contemplated that various embodiments of those described in FIGS. 4 to 7 are implemented in one energy storage system 1.

The approach according to the invention permits a more exact temperature control of the storage cells for optimizing their service life. It becomes possible to detect safety-critical temperatures of storage cells, electric cell connectors and electric module connectors of the energy storage system. Based on the more precise temperature detection, a more efficient automatic temperature control can take place.

### LIST OF REFERENCE NUMBERS

1 Energy storage system
10 Storage cell
11 First connection terminal
12 Second connection terminal
13 Power collector
14 Connection between the power collector and the connection terminal (welded and/or riveted connection)
15 Cell winding
16 Connection between the power collector and the cell winding
   (power collector)
17 Case
18 Side wall
19 Front side
20 Connection element
21 Cell connector
22 Module connector
23 Blind hole
24 Tab of the connection element
30 Temperature sensor unit
31 Temperature sensor
32 Temperature sensor

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. An apparatus for detecting temperature of an electrochemical energy storage system, comprising:
one or more storage cells of the energy storage system, each storage cell having two connection terminals;
connection elements operatively configured for electrically contacting associated connection terminals; and
a temperature sensor unit, the temperature sensor unit having a respective temperature sensor arranged on a particular connection terminal of at least one of the storage cells of the energy storage system.

2. The apparatus according to claim 1, wherein the temperature sensor of the temperature sensor unit is arranged on the particular connection terminal of a storage cell, which particular connection terminal has an electrical connection with a case of the storage cell.

3. The apparatus according to claim 1, wherein the temperature sensor of the temperature sensor unit is arranged directly on the particular connection terminal of at least one storage cell.

4. The apparatus according to claim 2, wherein the temperature sensor of the temperature sensor unit is arranged directly on the particular connection terminal of at least one storage cell.

5. The apparatus according to claim 3, wherein the temperature sensor is arranged in a blind hole of a connection element directly on the particular connection terminal.

6. The apparatus according to claim 4, wherein the temperature sensor is arranged in a blind hole of a connection element directly on the particular connection terminal.

7. The apparatus according to claim 1, wherein the temperature sensor of the temperature sensor unit is arranged on a connection element that is electrically and thermally conductingly coupled with one of the connection terminals.

8. The apparatus according to claim 2, wherein the temperature sensor of the temperature sensor unit is arranged on a connection element that is electrically and thermally conductingly coupled with one of the connection terminals.

9. The apparatus according to claim 7, wherein the temperature sensor is arranged on the connection element in an area of the connection element that is outside a connection area of the connection terminal and the connection element.

10. The apparatus according to claim 9, wherein the connection element has a tab that extends outside of the connection area of the connection terminal and the connection element; and
wherein the temperature sensor is arranged on the tab.

11. The apparatus according to claim 1, wherein the connection element is a cell connector operatively configured to electrically mutually connect connection terminals of two storage cells.

12. The apparatus according to claim 1, wherein the connection element is a module connector operatively configured to provide electrical contact with the energy storage system.

13. The apparatus according to claim 11, wherein the connection element is a module connector operatively configured to provide electrical contact with the energy storage system.

14. The apparatus according to claim 12, further comprising:
a plug-in connector operatively configured for providing electrical contact with the module connector of the energy storage system.

15. The apparatus according to claim 1, wherein the temperature sensor unit comprises two temperature sensors, said two temperature sensors being operatively arranged to detect temperatures at different storage cells; and
wherein temperature signals of the two temperature sensors are feedable to a logic unit for evaluation.

16. The apparatus according to claim 1, wherein the connection elements include at least one cell connector and at least one module connector, a cell connector electrically mutually connecting connection terminals of two storage cells and a module connector providing electrical contact for the energy storage system;
the apparatus further comprising:
two temperature sensors, a first temperature sensor being thermally coupled with a connection terminal of a storage cell whose connection terminal is electrically connected with a connection element constructed as a module connector, and a second temperature sensor being thermally coupled with a connection terminal of a storage cell whose two connection terminals are each electrically connected with a connection element constructed as a cell connector.
